(19) United States
(12) Patent Application Publication
(10) Pub. No.: US 2007/0094639 A1
(43) Pub. Date: Apr. 26, 2007

(54) Preparing assembly languague source code

(75) Inventors: Daniel Luke Kefford, Cambridgeshire (GB); Christopher Pedley, Cambridge (GB); Michael John Williams, Cambridgeshire (GB); Martyn Capewell, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/258,371

(22) Filed: Oct. 26, 2005

(51) Int. Cl. G06F 9/44

(52) U.S. Cl. 717/110

(57) ABSTRACT

A method and data processing apparatus for assisting a user when preparing assembly language source code to be executed by a processor core is provided. The assembly language source code comprises a sequence of assembly language instructions. The method comprises the steps of: receiving an assembly language instruction entered by the user; determining, with reference to a model representing the operation of the processor core when executing the sequence of assembly language instructions, whether a predetermined condition will occur due to a relationship between the assembly code instruction and at least one other assembly code instruction in the sequence of assembly language instructions which will cause the processor core to operate in an undesirable manner; and if the predetermined condition occurs, displaying to the user an indication of the relationship between the assembly code instruction and the at least one other assembly code instruction which will cause the processor core to operate in the undesirable manner. Providing such an indication assists the user when preparing the assembly language source code by alerting him to the fact that the performance of the code when being executed on the processor core may not be as high as may be possible.

### BACKGROUND OF THE INVENTION

1. Field of the Invention

The present invention relates to preparing assembly language source code. Embodiments of the present invention relate to techniques for assisting a user when preparing assembly language source code.

2. Description of the Prior Art

Techniques for preparing assembly language source code are known. Typically, a text editor is provided which enables a user to enter a sequence of assembly language instructions intended to be executed on a target processor core. Using the text editor, the user can navigate around the sequence of assembly language instructions and edit those instructions prior to those instructions being provided to a compiler.

Once the compiler has compiled the source code and created a target image comprising a sequence of machine code instructions, that target image may then be executed on the target processor core.

It is desired to provide improved techniques for preparing assembly language source code.

### SUMMARY OF THE INVENTION

According to one aspect of the present invention there is provided a method of assisting a user when preparing assembly language source code to be executed by a processor core, the assembly language source code comprising a sequence of assembly language instructions, the method comprising the steps of: receiving an assembly language instruction entered by the user; determining, with reference to a model representing the operation of the processor core when executing the sequence of assembly language instructions, whether a predetermined condition will occur due to a relationship between the assembly code instruction and at least one other assembly code instruction in the sequence of assembly language instructions which will cause the processor core to operate in an undesirable manner; and if the predetermined condition occurs, displaying to the user an indication of the relationship between the assembly code instruction and the at least one other assembly code instruction which will cause the processor core to operate in the undesirable manner.

The present invention recognises that programming using assembly language source code is a highly specialised activity. This is because to produce efficient code in this way requires a great deal of in-depth knowledge of the operation of the assembly language instructions and their interaction with the target processor core. Such programming is often reserved for extremely specialised tasks where the software engineer wishes to be certain that particular machine code instructions will be executed in a predetermined sequence on the target processor. Accordingly, it is desirable that the compiler generates the target image representing the assembly language instructions as faithfully as possible. Hence, many of the optimising functions that may be provided in a compiler for a high level language would typically be prevented from being included in an assembly language compiler in order to ensure that the target image fully reflects the source code.

However, the present invention also recognises that such an approach provides a number of drawbacks. For example, unless the software engineer has a complete and through grasp of the detailed operation of the assembly language source code on the target processor and can also fully comprehend the extensive interactions between instructions, the performance of the source code may be less than may otherwise be possible.

Accordingly, the present invention provides a technique which assists the user when preparing assembly language source code by identifying relationships between assembly code instructions which will cause the processor to operate undesirably.

When an assembly language instruction is entered by a user a determination is made as to whether a predetermined condition will occur as a result of a relationship between the entered assembly code instruction and another instruction in the sequence of assembly language instructions. This determination is made by referring to a model which models the operation of the processor core when executing the sequence of assembly language instructions. Should it be determined that a predetermined condition will occur then an indication is provided to the user which shows the relationship between the instructions which will cause the processor core to operate in an undesirable fashion.

It will be appreciated that providing such an indication assists the user when preparing the assembly language source code by alerting him to the fact that the performance of the code when being executed on the processor core may not be as high as may be possible.

Also, it will be appreciated that because these complex relationships and undesirable conditions can be identified by the model rather than relying on the knowledge of the user, the skill level of the user need not be as high as previously required. Furthermore, time the user needs to spend analysing the code need not be as high as previously required since these relationships will be identified automatically. Accordingly, programming using assembly language source code becomes more achievable for a wider range of users and the cost of producing such code may be reduced.

In embodiment, the undesirable manner comprises the processor core operating non-optimally due to the relationship between the assembly code instruction and at least one other assembly code instruction in the sequence of assembly language instructions.

Hence, the relationship between the assembly code instructions may cause the processor to operate in a manner which is less than the optimum performance possible from the processor core.

In one embodiment, the predetermined condition comprises an interlock due to a dependency between the assembly code instruction and at least one other assembly code instruction in the sequence of assembly language instructions which would cause the processor core to stall until the interlock has cleared.

Accordingly, the model is operable to determine when a dependence will occur between assembly code instructions resulting in an interlock. It will be appreciated that the occurrence of such an interlock will typically cause the processor core to stall until the interlock is cleared and that this will detrimentally affect the performance of the processor core.

In one embodiment, the step of displaying comprises highlighting the assembly code instruction and the at least one other assembly code instruction in the sequence of assembly language instructions which would cause the processor to stall until the interlock has cleared.

Hence, the instructions which will cause the interlock to occur will be highlighted and displayed to the user. This enables the user to rapidly and easily identify the instructions which will lead to reduced performance.

In one embodiment, the step of displaying comprises highlighting attributes of the assembly code instruction and the at least one other assembly code instruction in the sequence of assembly language instructions which would cause the processor to stall until the interlock has cleared.

Highlighting attributes, such as the registers or the memory locations which cannot be accessed until after the interlock has been cleared, enables the user to more precisely identify the exact cause of the poor performance of the processor core.

In one embodiment, the predetermined condition comprises the presence of a predetermined assembly language instruction as the assembly language instruction, the predetermined assembly language instruction being substitutable by an alternative assembly language instruction which is executable by the processor core in a more efficient manner within the sequence of assembly language instructions.

Hence, the model is able to determine when an alternative instruction could be used to replace an assembly language instruction present in the sequence, that alternative instruction executing more efficiently than the instruction which it could replace. It will be appreciated that in some situations some instructions may always execute more efficiently than others, irrespective of any relationship between them, and in those situations the user may simply be displayed with an indication of the particular single instruction which causes the processor to operate in an undesirable manner.

In one embodiment, the step of displaying comprises highlighting the predetermined assembly code instruction.

Accordingly, the user can readily identify those instructions which may be replaced by other instructions which would execute more efficiently.

In one embodiment, the method further comprises displaying an indication of the alternative assembly language instruction which is executable in a more efficient manner within the sequence of assembly language instructions by the processor core.

Hence, not only can the user be provided with an indication of an instruction which may not execute as efficiently as expected but he may also be provided with a suggested alternative instruction which will execute more efficiently.

In one embodiment, the predetermined condition comprises the presence of a plurality of predetermined assembly language instructions, the plurality of predetermined assembly language instructions including the assembly language instruction, the plurality predetermined assembly language instructions being substitutable by an alternative assembly language instruction which is executable in a more efficient manner by the processor core.

Accordingly, the model may also identify a situation where a number of instructions within the sequence of instructions would execute less efficiently than an alternative, typically single, replacement assembly language instruction.

In one embodiment, the step of displaying comprises highlighting the plurality of predetermined assembly code instructions.

By highlighting those instructions the user is able to readily identify the problem instructions.

In one embodiment, the method further comprises displaying an indication of the alternative assembly language instruction which is executable in a more efficient manner by the processor core.

Hence, the user may also be provided with a suggested alternative instruction which could be used to replace the less efficient combination of instructions.

In one embodiment, the method further comprises, in response to the user selecting one of the sequence of assembly language instructions, determining with reference to the model representing the operation of the processor core when executing the sequence of assembly language instructions, an earliest and a latest position within the sequence of assembly language instructions which the one of the sequence of assembly language instructions can be moved without altering the function of the sequence of assembly language instructions; and displaying to the user an indication of the earliest and the latest position within the sequence of assembly language instructions which the one of the sequence of assembly language instructions can be moved without altering the function of the sequence of assembly language instructions.

Hence, in the event that the user selects an instruction within the sequence, the model determines whether that instruction may be relocated to different positions within the sequence of instructions without affecting the intended operation of that sequence of instructions. The user is then provided with an indication of the earliest possible position within the sequence and the latest possible position within the sequence that the instruction could be moved to without causing the sequence of instructions to operate in a different way. It will be appreciated that this enables the user to readily appreciate the limits within which an instruction may be moved within the sequence without causing the code to behave differently.

In one embodiment, said predetermined condition comprises the presence of a predetermined assembly language instruction as said assembly language instruction, said predetermined assembly language instruction being substitutable by an alternative plurality of predetermined assembly language instructions which are executable in a more efficient manner by said processor core.

Hence, the user may also be provided with a suggested alternative sequence of instructions which could be used to replace the less efficient instruction.

In one embodiment, the method further comprises receiving an indication that at least one assembly code instruction is to be placed at a new position within the sequence of assembly language instructions thereby providing a revised sequence of assembly language instructions; determining, with reference to the model representing the operation of the processor core when executing the revised sequence of assembly language instructions, whether a predetermined condition will occur due to a relationship between assembly code instructions in the revised sequence of assembly language instructions which will cause the processor core to operate in an undesirable manner; and if the predetermined condition occurs, displaying to the user an indication of the relationship between the assembly code instructions in the revised sequence of assembly language instructions which will cause the processor core to operate in an undesirable manner.

Hence, when an indication is received that the ordering of the instructions within the sequence is to be changed, the model determines whether that new sequence of instructions will cause the processor core to operate undesirably and to display that to the user if such undesirable operation is identified. Accordingly, the user will be provided with feedback on the performance of the altered sequence in response to the sequence being altered. It will be appreciated that this is a useful tool when re-sequencing or editing instructions.

In one embodiment, the method further comprises, in the event that the predetermined condition occurs, applying a set of predetermined rules such that at least one assembly code instruction is selected to be placed at a new position within the sequence of assembly language instructions thereby providing the revised sequence of assembly language instructions.

Hence, should a predetermined condition occur, a set of rules may be applied which selects one or more assembly code instructions to be placed at different positions within the sequence of assembly language instructions. In this way, the re-sequencing of instructions can occur based on an automated process in order to address any problems within the sequence.

In one embodiment, the step of receiving comprises receiving from a user the indication that at least one assembly code instruction is to be placed at the new position within the sequence of assembly language instructions thereby providing the revised sequence of assembly language instructions.

Accordingly, the user may alternatively select one or more assembly code instructions and place them in different locations within the sequence.

In one embodiment, the assembly language source code is to be executed by any one of a plurality of processor cores and the step of determining comprises determining, with reference to a model representing the operation of each of the plurality of processor cores when executing the sequence of assembly language instructions, whether a predetermined condition will occur due to a relationship between the assembly code instruction and at least one other assembly code instruction in the sequence of assembly language instructions which will cause the one of the plurality of processor cores to operate in an undesirable manner.

Hence, the model is able to determine whether a problem will occur when executing the source code on any of a number of different processor cores. It will be appreciated that this provides significant advantages to the user since any one user is unlikely to have an in-depth understanding of the operation of such a range of processor cores. This provides significant benefits when the sequence of instructions is to be recompiled for execution on a different target processor core.

In one embodiment, the assembly language source code is to be executed using any one of a plurality of instruction sets executable by the processor core and the step of determining comprises determining, with reference to a model representing the operation of each of the plurality of instructions sets executable by the processor core, whether a predetermined condition will occur due to a relationship between the assembly code instruction and at least one other assembly code instruction in the sequence of assembly language instructions which will cause the processor core to operate in an undesirable manner.

Similarly, the model may determine when a problem may occur when executing the sequence of instructions using a different instruction set. It will be appreciated that this would be highly useful to the user when using different instruction sets. For example, an indication can be provided when a problem occurs when using one instruction set which will enable a decision to be taken on whether to execute that and/or other instructions using an alternative supported instruction set.

According to a second aspect of the present invention there is provided a computer program operable when executed on a computer to assist a user when preparing assembly language source code to be executed by a processor core, the assembly language source code comprising a sequence of assembly language instructions, the computer program comprising: an interface module operable to receive an assembly language instruction entered by the user; a model representing the operation of the processor core when executing the sequence of assembly language instructions operable to determine whether a predetermined condition will occur due to a relationship between the assembly code instruction and at least one other assembly code instruction in the sequence of assembly language instructions which will cause the processor core to operate in an undesirable manner; and a display module operable if the predetermined condition occurs to display to the user an indication of the relationship between the assembly code instruction and the at least one other assembly code instruction which will cause the processor core to operate in the undesirable manner.

According to a third aspect of the present invention there is provided a data processing apparatus for assisting a user when preparing assembly language source code to be executed by a processor core, the assembly language source code comprising a sequence of assembly language instructions, the data processing apparatus comprising: an interface for receiving an assembly language instruction entered by the user; model logic representing the operation of the processor core when executing the sequence of assembly language instructions for determining whether a predetermined condition will occur due to a relationship between the assembly code instruction and at least one other assembly code instruction in the sequence of assembly language instructions which will cause the processor core to operate in an undesirable manner; and a display controller for displaying to the user, if the predetermined condition occurs, an indication of the relationship between the assembly code instruction and the at least one other assembly code instruction which will cause the processor core to operate in the undesirable manner.

### BRIEF DESCRIPTION OF THE DRAWINGS

Embodiments of the present invention will now be described with reference to the accompanying drawings in which:

FIG. 1 illustrates schematically the arrangement of a scheduling editor according to an embodiment of the present invention;

FIG. 2 is a flow diagram illustrating the operation of the scheduling editor shown in FIG. 1;

FIG. 3 illustrates the highlighting of a hazard between two instructions;

FIG. 4 illustrates a suggested new location for an instruction to overcome the hazard;

FIG. 5 illustrates the highlighting of an area within which an instruction may be moved without changing the operation of the code;

FIG. 6 illustrates highlighting an area within which an instruction may be moved and areas within which moving that instruction will cause a hazard to occur; and

FIG. 7 illustrates highlighting a sequence of instructions which could be optimised.

### DESCRIPTION OF THE EMBODIMENTS

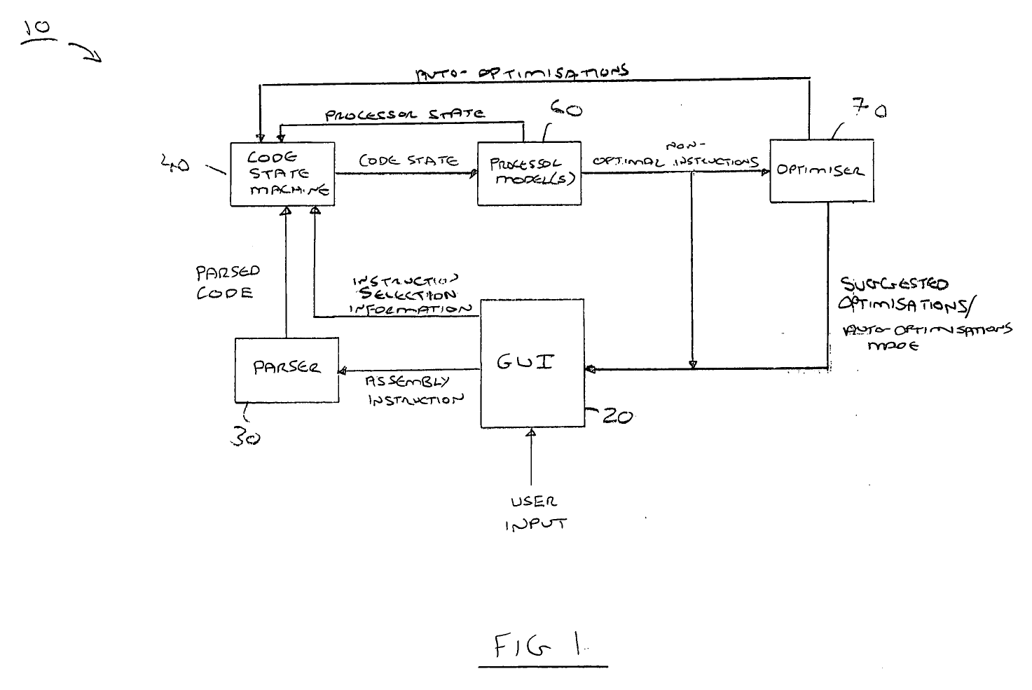

FIG. 1 illustrates a scheduling editor according to an embodiment of the present invention. The scheduling editor, generally 10, comprises a graphical user interface (GUI) 20 provided to enable interaction with a user. Coupled with the GUI 20 is a parser 30 and a code state machine 40. Coupled with the code state machine 40 is a processor model 60 and the parser 30. Coupled to the processor model 60 and the graphical user interface 20 is an optimiser 70.

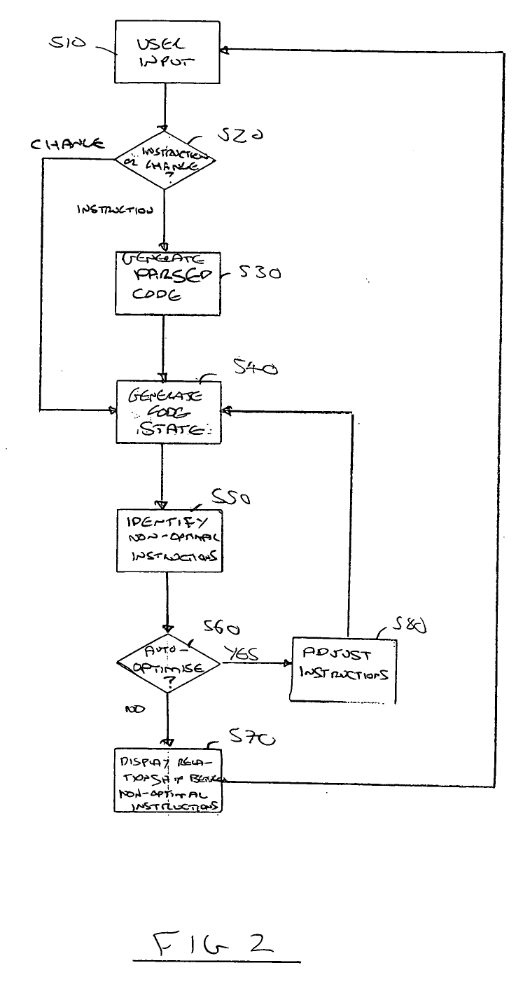

As will be explained in more detail with reference to FIG. 2 below, user input is received by the graphical user interface 20. The user input may take the form of, for example, details of a new instruction to be inserted into the sequence of instructions, the editing of an existing instruction, the re-sequencing of one or more instructions or any other command. The GUI 20 responds to the user input and provides a mechanism to enable the user to interact with the scheduling editor 10. Typically, the GUI 20 will take the form of a display showing sequential lines of assembly language instructions which are entered by the user, together with other textual and graphical information to assist the user when creating the sequence of assembly language instructions. The GUI 20 may apply predetermined formatting to that sequence of assembly language instructions, such as automated indentation, syntax colouring, auto completion and a quick “tool tip” API call, as known in the art.

The user's interactions with the GUI 20 is provided to the code state machine 40 either directly or via the parser 30. In the event that the user enters a new assembly language instruction then the GUI 20 passes this instruction to the parser 30 which then parses the instruction and provides the parsed code to the code state machine 40. In the event that the user adjusts the sequence of the instructions displayed on the GUI 20 or performs some other command, information relating to the re-sequencing or command is passed directly to the code state machine 40.

The code state machine 40 contains state information relating to the complete sequence of assembly language instructions entered. The code state machine 40, in conjunction with the processor model 60 which models the operation of the processor, or of a number of processors, each of which may support more than one instruction set. The code state machine 40 in conjunction with the processor model 60 simulates the operation of the processor when executing the sequence of assembly code instructions and determines with reference to a condition list (not shown) whether a condition exists between any of those instructions which will result in the processor core executing in a less than optimal manner. Hence, the condition list is pre-programmed with a predetermined list of relationships which, if they exist between instructions in the sequence will result in a condition which causes the processor core to not execute instructions in the most efficient manner possible.

Accordingly, the processor model 60, in conjunction with the code state machine 40, provides an indication of any instructions within the sequence of instruction which would, if left as they currently are, will result in the processor core operating less efficiently than would otherwise be possible. It will be appreciated that providing such an indication is readily possible given a knowledge of the detailed instruction timings of a particular processor core.

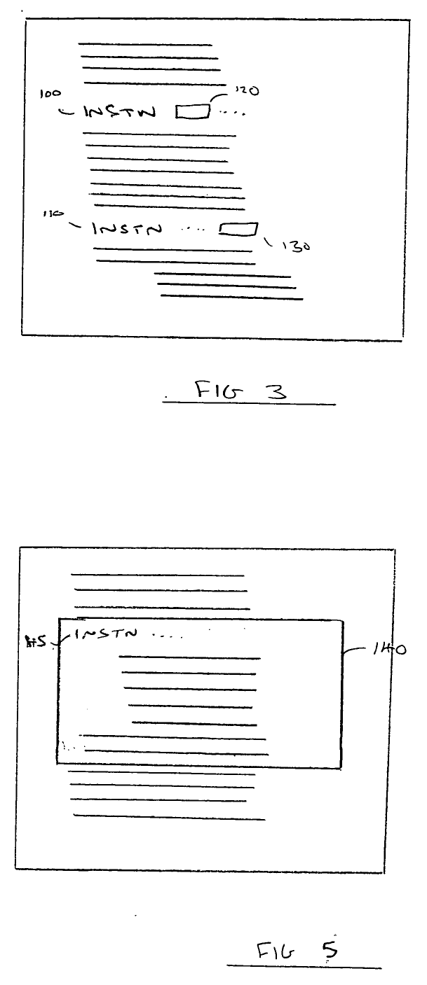

This information, detailing the non-optimal instructions, is provided to the graphical user interface 20 and the graphical user interface 20 responds by highlighting the offending instructions and indicating, where appropriate, the particular attributes of those instructions which result in non-optimal performance, as will be explained in more detail with reference to FIGS. 3 to 7 below.

The details of the non-optimal instructions are also provided to an optimiser 70. The optimiser 70 will review this information and will determine, based upon a pre-programmed, predetermined set of rules, whether there are any optimisations which could be performed. If the optimiser function has been activated by the user, through the GUI 20, then an indication of these optimisations may be provided to the GUI 20 for display to the user. These optimisations may be determined by the optimiser through interaction with the code state machine 40 and the processor model 60. For example, the optimiser 70 may provide an indication of how to re-sequence the instructions or how it would be possible to substitute some instructions for other instructions, as will also be described in more detail with reference to FIGS. 3 to 7 below. Again, it will be appreciated that providing such an indication is readily possible given a knowledge of the detailed instruction timings of a particular processor core.

In the event that the user makes a change to the instructions, either himself or by selecting one of the suggested optimisations provided by the optimiser 70, then this change to the sequence of instructions then fed-back to the code state machine 40 either directly or via the parser 30, where appropriate.

In this way, it will be appreciated that the user is assisted in producing the assembly language source code since he is alerted to any relationships between assembly code instructions (such as a hazard condition leading to an interlock situation) which would cause the processor core to operate in a non-optimal manner.

FIG. 2 illustrates in more detail the operation of the scheduling editor 10 illustrated in FIG. 1.

At step S10, user input is provided via the GUI 20. This user input may comprise, for example, entering a new instruction, re-sequencing instructions, editing or deleting instructions, accepting suggested optimisations, and the like.

At step S20, the GUI 20 determines whether the user input related to the provision of a new or edited instruction, in which case processing proceeds to step S30 or whether the input related to some change in the arrangement of the sequence of instructions, in which case processing proceeds to step S40.

At step S30, the parser 30 generates parsed code from the entered or edited instruction and passes this parsed code to the code state machine 40.

At step S40, the code state machine 40 generates code state representing the new or changed sequence of instructions.

At step S50, the code state machine 40, in conjunction with the processor models 60, simulates the operation of the processor core when executing the sequence of instructions. Also, the code state machine 40, in conjunction with the processor models 60, identifies any non-optimal instructions and the relationships between them by reference to a rule set which indicates relationships between instructions which will result in the non-optimal performance of the processor core. Information relating to these inefficient instructions and the relationships between them is passed to the optimiser 70 and to the GUI 20 in order to update the screen displayed to the user, as will be explained in more detail with reference to FIGS. 3 to 7 below.

At step S60, a determination is made as to whether auto-optimisation should occur.

If no auto-optimisation is to occur (meaning that the optimiser 70 has not been activated) then the details of the non-optimal instructions and the relationships between those instructions which cause poor performance are provided to the GUI 20. The GUI 20 then highlights to the user those instructions and the relationships which will result in poor performance.

In the event that auto optimisation is to occur (meaning that the optimiser 70 has been activated) then, at step S80, the optimiser 70 will adjust the instructions within the sequence of instructions by either moving one or more of those instructions in accordance with predetermined rules or by substituting some instructions with other instructions and will feed that information back to the code state machine 40. The code state machine 40 will then once again, in conjunction with the processor model 60, determine whether any non-optimal instructions still exist. This will continue until either all of the non-optimised instructions have been resolved or until a minimum number of those non-optimal instructions remain.

FIG. 3 illustrates schematically the display provided by the GUI 20 when non-optimal instructions are identified. In this example, a hazard condition is shown which will result in interlock due to a dependency between two instructions 100, 110. As shown in FIG. 3, the processor model 60 provides information to enable the two instructions 100, 110 to be highlighted. Also, the information identifies the particular attributes 120, 130 of these instructions, which will also be highlighted to assist the user in identifying the cause of the interlock. Accordingly, the user is able to readily identify one or more combinations of instructions which will lead to the inefficient operation of the processor, and also identify the features of those instructions which will lead to this inefficiency.

FIG. 4 shows a further indication provided to the user in the event that an auto-optimisation has been enabled. The optimiser 70 provides an indication of a suggested new location 115 one of the two instructions 100, 110 which would enable the interlock hazard to be removed. The user may then accept the auto-optimisation suggestion, select a different location for the instructions or may ignore the condition altogether. It will be appreciated that the optimiser 70 may also provide an indication of a suggested new location for the other instruction, or indeed suggested new locations for both instructions 100, 110.

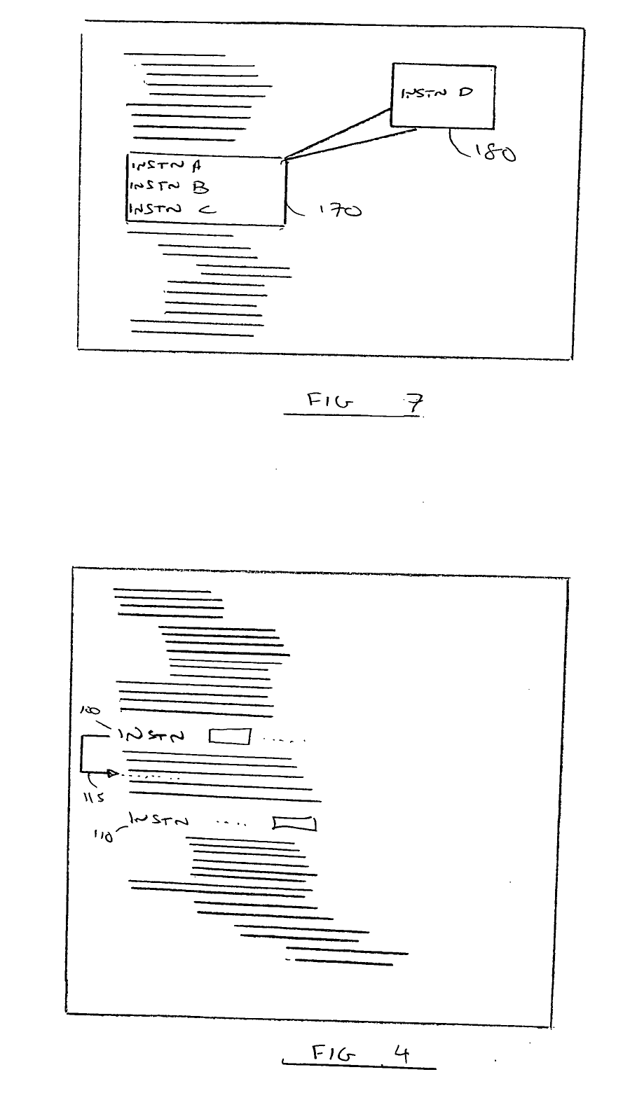

FIG. 5 illustrates an indication provided to the user when selecting one of the instructions 145 within the sequence. When the instruction 145 within the sequence is selected, the code state machine 40, in conjunction with the processor model 60 will determine a code region 140 within which that instruction 145 may be moved without affecting the overall operation of the sequence of instructions. Accordingly, the user may then drag and drop that instruction 145 to any location within the boundary of the code region 140 with the certain knowledge that this re-sequencing will not affect the operation of the code. It will be appreciated that this indication may be provided in addition to the indications provided in FIGS. 3 and 4.

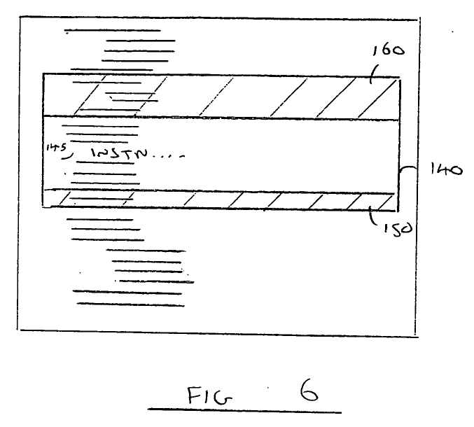

FIG. 6 illustrates a further enhancement in which the code region 140 illustrated in FIG. 4 is provided with sub-regions 150 and 160 which show areas within the code region which, whilst the operation of the code will not be affected, if the instruction 145 is placed within the regions 150 and 160 then this will result in a hazard or other condition occurring. Accordingly, the user is provided with a further indication of possible locations which that instruction 145 may be moved to.

FIG. 7 illustrates the highlighting of a plurality of instructions 170 which have been identified as being a series of non-optimal instructions. An indication of an optimised instruction 180 may also be provided to suggest to the user a substitution that may be made in order to improve the performance of the sequence of instructions.

Whilst FIG. 7 shows a plurality of instructions being substituted by a single instruction, it will be appreciated that a single instruction may be highlighted which could be replaced by another more efficient instruction or a single instruction may be highlighted which could be replaced by a more efficient sequence of instructions .

Accordingly, a technique is provided which assists the user when preparing assembly language source code by identifying relationships between assembly code instructions which will cause the processor to operate undesirably. This determination is made dynamically as the code is entered or changed and provides near real-time feedback to the user of any optimisations that could be made by the user to improve the performance of the code. Providing such an indication assists the user when preparing the assembly language source code by alerting him to the fact that the performance of the code when being executed on the processor core may not be as high as may be possible.

Because complex relationships leading to undesirable conditions can be identified by the model rather than relying on the knowledge of the user, the skill level of the user may be lower than previously required. Also, the time the user needs to spend analysing the code need not be as high as previously required since these relationships will be identified automatically. Accordingly, programming using assembly language source code becomes more achievable for a wider range of users and the cost of producing such code may be reduced.

Although a particular embodiment of the invention has been described herein, it would be apparent that the invention is not limited thereto, and that many modifications and additions may be made within the scope of the invention. For example, various features of the following dependent claims could be made with features of the independent claims without departing from the scope of the present invention.

We claim:

1. A method of assisting a user when preparing assembly language source code to be executed by a processor core, said assembly language source code comprising a sequence of assembly language instructions, said method comprising the steps of:
receiving an assembly language instruction entered by said user;
determining, with reference to a model representing the operation of the processor core when executing said sequence of assembly language instructions, whether a predetermined condition will occur due to a relationship between said assembly code instruction and at least one other assembly code instruction in said sequence of assembly language instructions which will cause said processor core to operate in an undesirable manner; and
if said predetermined condition occurs, displaying to said user an indication of said relationship between said assembly code instruction and said at least one other assembly code instruction which will cause said processor core to operate in said undesirable manner.

2. The method of claim 1, wherein said undesirable manner comprises said processor core operating non-optimally due to said relationship between said assembly code instruction and at least one other assembly code instruction in said sequence of assembly language instructions.

3. The method of claim 1, wherein said predetermined condition comprises an interlock due to a dependency between said assembly code instruction and at least one other assembly code instruction in said sequence of assembly language instructions which would cause said processor core to stall until said interlock has cleared.

4. The method of claim 3, wherein said step of displaying comprises highlighting said assembly code instruction and said at least one other assembly code instruction in said sequence of assembly language instructions which would cause said processor to stall until said interlock has cleared.

5. The method of claim 3, wherein said step of displaying comprises highlighting attributes of said assembly code instruction and said at least one other assembly code instruction in said sequence of assembly language instructions which would cause said processor to stall until said interlock has cleared.

6. The method of claim 1, wherein said predetermined condition comprises the presence of a predetermined assembly language instruction as said assembly language instruction, said predetermined assembly language instruction being substitutable by an alternative assembly language instruction which is executable in a more efficient manner within said sequence of assembly language instructions by said processor core.

7. The method of claim 6, wherein said step of displaying comprises highlighting said predetermined assembly code instruction.

8. The method of claim 7, comprising:
displaying an indication of said alternative assembly language instruction which is executable in a more efficient manner within said sequence of assembly language instructions by said processor core.

9. The method of claim 1, wherein said predetermined condition comprises the presence of a plurality of predetermined assembly language instructions, said plurality of predetermined assembly language instructions including said assembly language instruction, said plurality predetermined assembly language instructions being substitutable by an alternative assembly language instruction which is executable in a more efficient manner by said processor core.

10. The method of claim 9, wherein said step of displaying comprises highlighting said plurality of predetermined assembly code instructions.

11. The method of claim 10, comprising:
displaying an indication of said alternative assembly language instruction which is executable in a more efficient manner by said processor core.

12. The method of claim 11, comprising:
in response to said user selecting one of said sequence of assembly language instructions, determining with reference to said model representing the operation of the processor core when executing said sequence of assembly language instructions, an earliest and a latest position within said sequence of assembly language instructions which said one of said sequence of assembly language instructions can be moved without altering the function of said sequence of assembly language instructions; and
displaying to the user an indication of said earliest and said latest position within said sequence of assembly language instructions which said one of said sequence of assembly language instructions can be moved without altering the function of said sequence of assembly language instructions.

13. The method of claim 1, wherein said predetermined condition comprises the presence of a predetermined assembly language instruction as said assembly language instruction, said predetermined assembly language instruction being substitutable by an alternative plurality of predetermined assembly language instructions which are executable in a more efficient manner by said processor core.

14. The method of claim 1, comprising:
receiving an indication that at least one assembly code instruction is to be placed at a new position within said sequence of assembly language instructions thereby providing a revised sequence of assembly language instructions;
determining, with reference to said model representing the operation of the processor core when executing said revised sequence of assembly language instructions, whether a predetermined condition will occur due to a relationship between assembly code instructions in said revised sequence of assembly language instructions which will cause said processor core to operate in an undesirable manner; and
if said predetermined condition occurs, displaying to the user an indication of said relationship between said assembly code instructions in said revised sequence of assembly language instructions which will cause said processor core to operate in an undesirable manner.

15. The method of claim 14, comprising:
in the event that said predetermined condition occurs, applying a set of predetermined rules such that at least one assembly code instruction is selected to be placed at a new position within said sequence of assembly language instructions thereby providing said revised sequence of assembly language instructions.

16. The method of claim 14, wherein said step of receiving comprises receiving from a user said indication that at least one assembly code instruction is to be placed at said new position within said sequence of assembly language instructions thereby providing said revised sequence of assembly language instructions.

17. The method of claim 1, wherein said assembly language source code is to be executed by any one of a plurality of processor cores and said step of determining comprises determining, with reference to a model representing the operation of each of said plurality of processor cores when executing said sequence of assembly language instructions, whether a predetermined condition will occur due to a relationship between said assembly code instruction and at least one other assembly code instruction in said sequence of assembly language instructions which will cause said one of said plurality of processor cores to operate in an undesirable manner.

18. The method of claim 1, wherein said assembly language source code is to be executed using any one of a plurality of instruction sets executable by said processor core and said step of determining comprises determining, with reference to a model representing the operation of each of said plurality of instructions sets executable by said processor core, whether a predetermined condition will occur due to a relationship between said assembly code instruction and at least one other assembly code instruction in said sequence of assembly language instructions which will cause said processor core to operate in an undesirable manner.

19. A computer program operable when executed on a computer to assist a user when preparing assembly language source code to be executed by a processor core, said assembly language source code comprising a sequence of assembly language instructions, said computer program comprising:
an interface module operable to receive an assembly language instruction entered by said user;
a model representing the operation of the processor core when executing said sequence of assembly language instructions operable to determine whether a predetermined condition will occur due to a relationship between said assembly code instruction and at least one other assembly code instruction in said sequence of assembly language instructions which will cause said processor core to operate in an undesirable manner; and
a display module operable if said predetermined condition occurs to display to the user an indication of said relationship between said assembly code instruction and said at least one other assembly code instruction which will cause said processor core to operate in said undesirable manner.

20. A data processing apparatus for assisting a user when preparing assembly language source code to be executed by a processor core, said assembly language source code comprising a sequence of assembly language instructions, said data processing apparatus comprising:
an interface for receiving an assembly language instruction entered by said user;
model logic representing the operation of the processor core when executing said sequence of assembly language instructions for determining whether a predetermined condition will occur due to a relationship between said assembly code instruction and at least one other assembly code instruction in said sequence of assembly language instructions which will cause said processor core to operate in an undesirable manner; and
a display controller for displaying to said user, if said predetermined condition occurs, an indication of said relationship between said assembly code instruction and said at least one other assembly code instruction which will cause said processor core to operate in said undesirable manner.
